(19) United States
(12) Patent Application Publication
(10) Pub. No.: US 2014/0359060 A1
(43) Pub. Date: Dec. 4, 2014

(54) METHOD AND SYSTEM FOR LOCATION-BASED DIGITAL GOLF MEDIA DELIVERY

(71) Applicant: ARC MEDIA INC., Waterloo (CA)

(72) Inventors: Jonathon Charles Eric LUCAS, Waterloo (CA); Andrew Martin ASKES, Thorndale (CA)

(21) Appl. No.: 13/907,008

(22) Filed: May 31, 2013

(51) Int. Cl. H04L 29/08; H04W 4/00; G06K 7/10

(52) U.S. Cl. CPC H04L 67/18; G06K 7/10237; H04L 67/06; H04W 4/008; A63F 2300/00; A63B 2243/0029; A63B 57/00
USPC 709/217; 340/10.4

(57) ABSTRACT

According to embodiments described in the specification, systems and methods are provided for location-based digital golf media delivery. The method includes the steps of, in a user device including a processor, a display, and a sensor, sensing a code at a golf course location using the sensor, accessing a link to digital golf media from the code, wherein the link is determined based on one or more redirect parameters, and displaying the digital golf media on the display.

### FIELD OF TECHNOLOGY

The present disclosure relates to digital golf media. Certain embodiments provide a system and method for location-based digital golf media delivery.

### BACKGROUND

Various techniques have been developed for delivering or providing golf media to players, such as providing golf course maps on score cards. However, this approach can be limited as the information is static, can be difficult to navigate, and does not change based on location or time considerations. Similar limitations can be encountered with the use of digital scorecard devices or applications. Contextual, timely, relevant, and/or rich multi-media presentations may not be available with such previous approaches.

Improvements in systems and methods for location-based digital golf media delivery are desirable.

The foregoing examples of the related art and limitations related thereto are intended to be illustrative and not exclusive. Other limitations of the related art will become apparent to those of skill in the art upon a reading of the specification and a study of the drawings.

### BRIEF DESCRIPTION OF THE DRAWINGS

Examples are illustrated with reference to the attached figures. It is intended that the examples and figures disclosed herein are to be considered illustrative rather than restrictive.

FIG. 1 illustrates a system for location-based digital golf media delivery in accordance with an example;

FIG. 2 illustrates a method for location-based digital golf media delivery in accordance with an example, in a user device;

FIG. 3 illustrates a method for location-based digital golf media delivery in accordance with an example, in a server;

FIG. 4 is a view of a sign and the user device of FIG. 1 in accordance with an example;

FIG. 5 is a schematic view of the user device of FIG. 1 in accordance with an example;

FIG. 6 is a schematic view of a database of the server of FIG. 1 in accordance with an example;

FIG. 7 is a schematic view of the database of FIG. 6 in accordance with an example; and

FIG. 8 depicts a navigable interface on a display of the user device of FIG. 1 in accordance with an example.

### DETAILED DESCRIPTION

The following describes a system and a method for location-based digital golf media delivery. The method includes the steps of, in a user device including a processor, a display, and a sensor, sensing a code at a golf course location using the sensor, accessing a link to digital golf media from the code, wherein the link is determined based on one or more redirect parameters, and displaying the digital golf media on the display.

Throughout the following description, specific details are set forth in order to provide a more thorough understanding to persons skilled in the art. However, well-known elements may not be shown or described in detail to avoid unnecessarily obscuring of the disclosure. Accordingly, the description and drawings are to be regarded in an illustrative rather than a restrictive, sense.

This disclosure relates generally to digital golf media and particularly to systems and methods for location-based digital golf media delivery.

Advantageously, the system according to examples disclosed herein enables delivery of timely, relevant, and/or dynamic digital golf media to user devices, including topographical information, video clips, motion graphics, audio commentary, dynamic or real-time pin placement details, and contextual advertisements, among others. The digital golf media can be associated with codes posted on signs in multiple locations throughout a golf course. According to disclosed examples, the signs can be static and still facilitate delivery of changing or dynamic digital golf media.

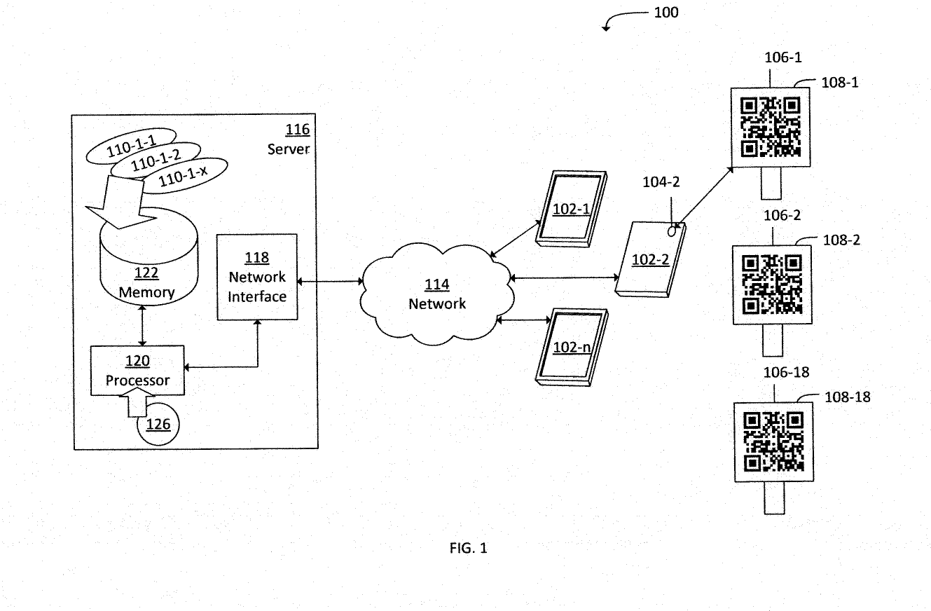

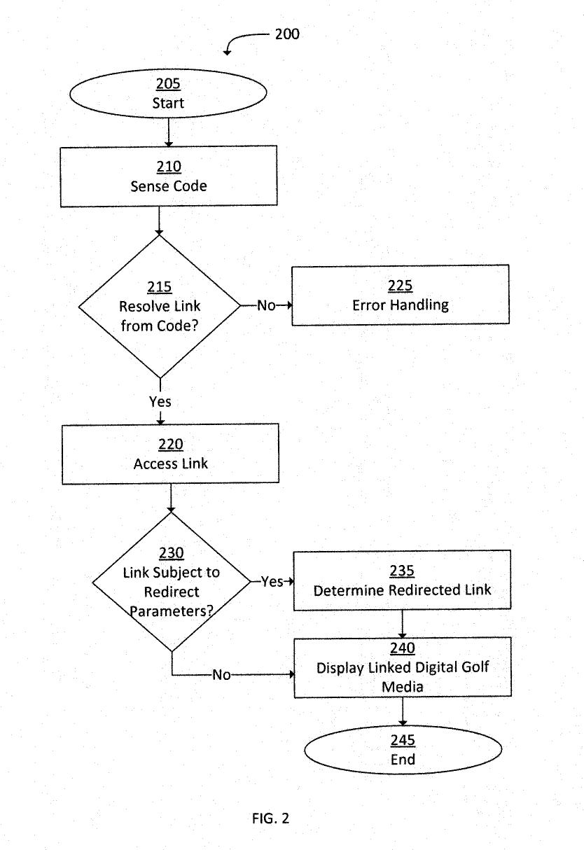

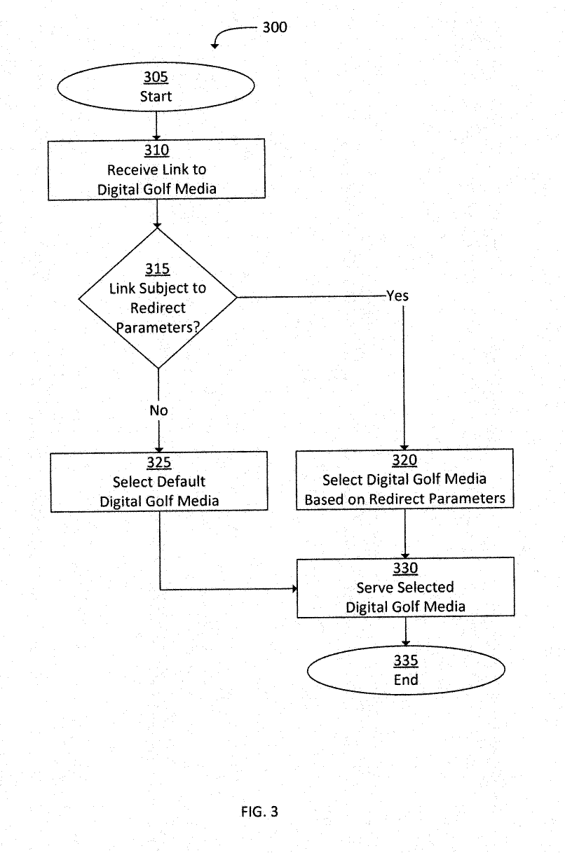

The following description provides, with reference to FIG. 1, detailed descriptions of exemplary systems for location-based digital golf media delivery. Detailed descriptions of corresponding computer-implemented methods are provided in connection with FIG. 2 and FIG. 3.

A diagram of an example of a system 100 for location-based digital golf media delivery is shown in FIG. 1.

According to this example, the system 100 includes one or more user devices 102-1, 102-2, . . . 102-n (generically referred to herein as “user device 102” and collectively as “user devices 102”; this nomenclature will also be used for other elements herein), all of which are connected to a server 116 via a network 114. The system 100 also includes one or more signs 106, as discussed below.

The user device 102 is typically a mobile device such as a smart phone, tablet, or wearable computer, but can extend to any of a desktop computer, laptop computer, and the like. As depicted schematically in FIG. 5, the user device 102 can include a processor 504 (or alternatively one or more processors), a memory 508, input devices including a sensor 104 (and a keyboard and a microphone, in some examples), output devices 512 (including a display and a speaker in some examples), and a network interface device 506 as described below in connection with the server 116. The user device 102 can be operated by a player or caddy.

The user device 102 includes a sensor 104 for scanning a code 108. In one example, the sensor 104 can be a quick response code sensor (QR code sensor) or barcode scanner such as a camera or other imaging subsystem. According to other examples, the sensor 104 can be a near field communication tag reader (NFC tag reader), a global positioning system sensor (GPS sensor), or a shortened link or shortlink reader. The user device 102 can include one or more sensors 104.

Use of the term code 108 in this specification encompasses a store of digital content or media, particularly content or media associated with a golf course location (e.g., digital golf media). In one example, the code 108 resolves to an address or link (e.g., uniform resource locator) to digital golf media. The code 108 can be a barcode such as a QR code, an NFC tag, or a shortlink reader. In one example, the code 108 can be a geocoded boundary parameter or other technique that permits a proximity to be detected between the user device 102 and the golf course location.

Generally, the codes 108 are selected for compatibility with the sensors 104. Each code 108 can be associated with one or more digital golf media, as discussed below, and can be printed on or otherwise attached to a sign 106 of the system 100.

The system 100 can include one or more signs 106-1, 106-2, . . . 106-o. In the example of FIG. 1, the number of signs is 18, corresponding to one sign per golf hole for a standard 18-hole course. Each sign 106 can be a laminated printing, a carving, a product of machining, or otherwise fabricated.

According to some examples, the codes 108 are displayed or otherwise attached to signs 106. Each sign 106 can be positioned near a golf hole such as beside a teeing ground location. This allows a sensor 104 of the user device 102 to sense the code 108 and access digital golf media for the location as the player is preparing for a tee shot.

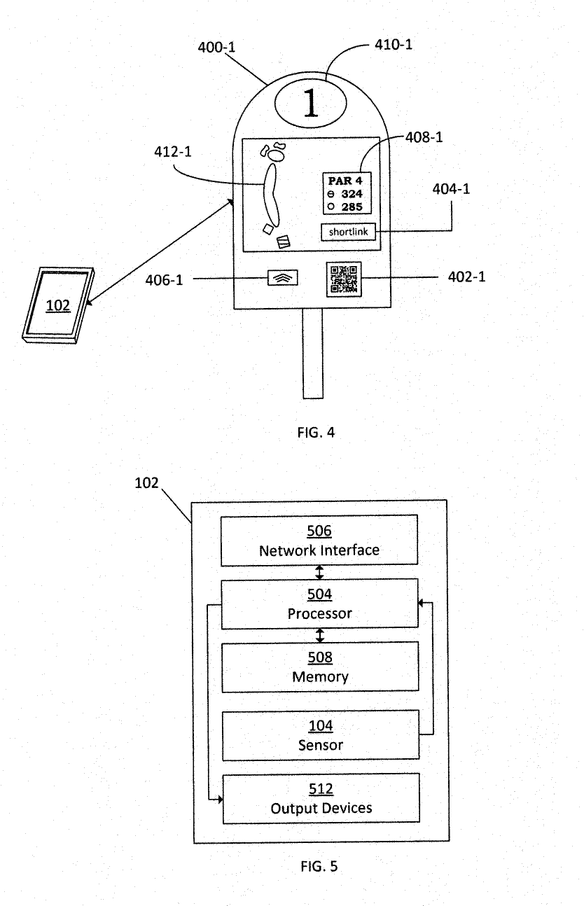

One or more codes 108 can be attached to the sign 106. In the example of FIG. 1, the sign 106-1 for the first golf hole includes code 108-1 that is a QR code, the sign 106-2 for the second golf hole includes code 108-2, and so on. In the example of FIG. 4, the sign 400-1 for the first golf hole (indicated by the label 410-1) includes a QR code 402-1, a shortlink 404-1, and an embedded NFC tag 406-1. The sign 400-1 can also include a hole number label 410-1, a par and yardage indicator 408-1, and a map 412-1. It will be apparent that to update the information contained in the indicator 408, the label 410, and the map 412, physical modifications to the sign 400-1 would be required. In contrast, where digital golf media associated with the first hole requires a change or an update, the codes 108 as displayed do not necessarily require any modification.

According to disclosed examples, each code 108 can be a QR code, an NFC tag, a shortlink, or a geo-coded boundary, or some combination of these codes 108. It will be apparent that any content encoding scheme to generate the codes 108 can be employed without departing from the scope of the present disclosure.

A QR code, examples of which are shown at 108 of FIGS. 1 and 402 of FIG. 4, comprises dots arranged in a square grid on a white or contrasting background, which can be read by an imaging device (such as a camera of the user device 102) and processed using error correction techniques until the image can be appropriately interpreted. The image can be processed using a scanning application loaded on an electronic device 102. According to one example, the code 108 or QR code 402 can encode or store a link (e.g., an address or Uniform Resource Locator (URL)) to digital golf media.

An NFC tag or sticker, an example of which is shown at 406-1 of FIG. 4, includes a passive, unpowered, short-range wireless chip that can be powered by an NFC device such as a mobile device, an example of which can be the user device 102. The NFC tag 406-1 returns stored content upon query by the NFC device. According to one example, the NFC tag 406-1 can encode or store a link to digital golf media.

A shortened link or shortlink, an example of which is shown at 402-1 of FIG. 4, is a link that has been made substantially shorter in length and still directs to the required resource (i.e., the unshortened or long link). A shortlink can be created by using domain name redirect techniques. Content can be returned upon text entry of the shortlink 402-1 in a browser application, or similar application, of the user device 102.

In other examples, the code 108 is a geocoded boundary where the sensor 104 is a GPS sensor. When the user device 102 detects that the geocoded boundary has been entered, or more generally a threshold proximity to the golf course location is detected, digital golf media associated with the geocoded boundary can be accessed or presented on the display of the user device 102. The digital golf media can be presented automatically or upon demand by the user device 102.

As mentioned, any content encoding scheme can be used to generate the codes 108. Other examples which are encompassed by the present specification include Bluetooth™ or other short distance wireless communication protocols. Where the code 108 is a Bluetooth™ module attached to the sign 106, appropriate modifications to the sign 106 can be made including the addition of a power supply to power the module. In one example, the power supply can be a solar or sunlight-powered power supply.

As discussed above, the user devices 102 can be connected to the server 116. The server 116 can be a server or mainframe within a housing containing an arrangement of one or more processors 120 (also referred to as “the processor 120”), memory 122 (i.e., volatile memory such as random access memory or RAM and/or persistent memory such as hard disk devices), and a network interface device 118, all of which are interconnected by a bus. Many computing environments implementing the server 116 or components thereof are within the scope of this specification.

The server 116 includes a network interface device 118 interconnected with the processor 120. The network interface device 118 allows the server 116 to communicate with other computing devices such as the user devices 102 via a link with the network 114. The network 114 can include any suitable combination of wired and/or wireless networks, including but not limited to a Wide Area Network (WAN) such as the Internet, a Local Area Network (LAN), HSPA/EVDO/LTE cell phone networks, WiFi networks, and the like.

The server 116 stores, in the memory 122, a plurality of computer readable instructions executable by the processor 120. These instructions can include an operating system (“OS”) and a variety of applications. Among the applications in the memory 122 is an application 105 (also referred to herein as “redirect application 105”; not shown in FIG. 1). When the processor 120 executes the instructions of the redirect application 105, the processor 120 is configured to perform various functions specified by the computer readable instructions of the redirect application 105, shown as redirect engine 126 in FIG. 1, and as will be discussed below in greater detail.

The server 116 stores in the memory 122 a redirect database 124 (not shown in FIG. 1) maintaining associations (links) between codes and digital golf media. The server 116 can also store in the memory 122, a media database 128 (not shown in FIG. 1) of digital golf media 110 as discussed below in greater detail. Optionally, the memory 122 also stores a user profile database 130 (not shown in FIG. 1). Each of the redirect database 124, the media database 128, and the user profile database 130 can be a database application loaded on the server 116, a stand-alone database server or a virtual machine in communication with the network interface device 118 of the server 116, or any other suitable database. In one example, the media database 128 is a user-generated video website.

In operation, the user device 102 interacts with server 116 to access content linked from the codes 108. The server 116 responds to queries of the redirect database 124 from user devices 102 received at the network interface device 118. For example, the user device 102 can communicate with the server 116 via the network 114 using a client application 502 (not shown in FIG. 1) loaded on the memory of the user device 102. In one example, the client application 502 is a web browser or native application that provides logic to the processor 504 for sensing of codes 108. The client application 502 senses the code 108, accesses a link to digital golf media from the code, and displays the digital golf media on the display of the user device 102.

The redirect engine 126 of the server 116 adjusts the associations or links between codes and digital golf media according to one or more redirect parameters. The redirect parameters include: a time of day parameter (e.g. morning or afternoon), a day of week parameter (e.g. weekend or weekday), a week of month parameter, a month of year parameter (e.g. seasonal), a location parameter, a weather parameter (e.g. sunny, cloudy, rainy, hot, cold, humid), as well as parameters that can be administrator(s)-determined parameter (e.g. default or changed pin placement, quantity or type of digital golf media such as advertisements), or based on the user profile database 130 or cookies stored on the user device 102 (e.g., to provide tailored or targeted advertisements based on stored profile information of the user device 102 or past usage of a browser application). Dependent on the redirect parameters, the digital media associated with a code 108 can be different. The redirect engine 126 changes the associations between codes 108 and digital golf media. Associations of digital golf media to codes 108 can be made or adjusted at pre-determined times (e.g. daily or upon a periodic schedule) or at the time when the code 108 is sensed by the user device 102.

In one example, the sign 106 at the first hole (i.e., hole #1) includes a code 108 such as a shortlink (e.g., golfvideos.ca/sv-1). Upon receipt of the code 108, the server 116 redirects the client application 502 loaded on the user device 102 to digital golf media for the first hole using selected parameters. The selected parameters can include a time of day parameter, a day of week parameter, a week of month parameter, a month of year parameter, a weather parameter, and so on. For example, if the time of day is after 11:00 am, the digital golf media, can include a pre- or post-roll advertisement for a meal or beverage offering at the clubhouse. The time of day can be dependent on the location of the user device 102 or the server 116. Alternatively, if the day of week is Wednesday, for example, the digital golf media can include a pre- or post-roll advertisement for a dinner special offering at the clubhouse. It will be apparent that the digital golf media assets can relate to upcoming events, pro shop sales, and other types of location- or time-based announcements or activities.

In one example, the redirect parameter can be a variable delivered to the client application 502 on the user device 102 that changes what is shown in a frame of the client application 502. JavaScript code dependent on the redirect variable changes html code and thereby changes or alters content that is displayed on the display of the user device 102.

In some examples, the server 116 and the network 114 can be omitted and the substantial functions of the server 116 can be performed in the client application 502 loaded on the user device 102. This type of configuration is desirable when network connectivity is non-existent or poor between the server 116 and the user device 102 and generally when offline access to digital golf media is needed.

A flowchart illustrating an example of a disclosed method of digital golf media delivery, in a user device, is shown in FIG. 2. This method can be carried out by the client application 502 or other software executed by, for example, the processor 504 of the user device 102. The method can contain additional or fewer processes than shown and/or described, and can be performed in a different order. Computer-readable code executable by the processor 504 of the user device 102 to perform the method can be stored in a computer-readable storage medium, such as a non-transitory computer-readable medium.

With reference to FIG. 2, a method 200 starts at 205 and, at 210, the code 108 is sensed by the sensor 104 of the user device 102. At 215, the code 108 is resolved to determine a link from the code 108. If the code 108 cannot be resolved, then error handling functions can be invoked at 225. At 220, the link is accessed. In one example, the link is a query or request for content from the server 116. The link can be subject to redirect parameters and this is determined at 230. If so, then a redirect link is determined at 235 and the linked (redirected) digital golf media is displayed on the display of the user device 102. If not, then the linked (default) digital golf media can be displayed at 240, and the method ends at 245.

A flowchart illustrating an example of a disclosed method of digital golf media delivery, in a server, is shown in FIG. 3. This method can be carried out by the redirect application 105 or other software executed by, for example, the processor 120 of the server 116. The method can contain additional or fewer processes than shown and/or described, and can be performed in a different order. Computer-readable code executable by at least one processor 120 of the server 116 to perform the method can be stored in a computer-readable storage medium such as a non-transitory computer-readable medium.

With reference to FIG. 3, a method 300 starts at 305 and, at 310, the query (link) for digital golf media is received from a user device 102 via the network interface device 118 of the server 116. At 315, the redirect engine 126 provides logic to the processor 120 to determine if the query (link) is subject to redirect parameters. If so, then at 320, a link to digital golf media based on the redirect parameters is selected, and at 330, the digital golf media is served or transmitted to the user device 102. If not, then, at 325, default digital golf media is selected, and at 330, served or transmitted to the user device 102, and the method ends at 335.

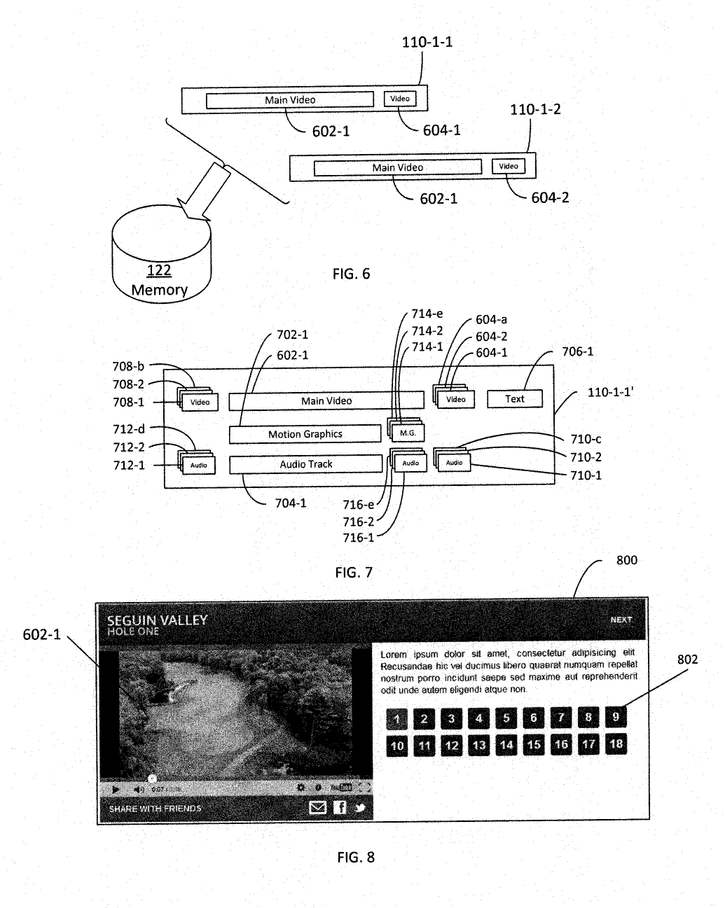

The media database 128 includes one or more digital golf media 110 for access by user devices 102. As shown in FIG. 6, digital golf media 110 includes one or more digital media assets such as video clip assets, motion graphics assets, audio track assets, text assets, advertisements assets such as pre-roll advertisement assets or post-roll advertisement assets, etc. In one example, the digital golf media 110 includes a video clip asset that is a “flyover” of a golf course location such as a golf course hole from a teeing ground to the green or pin location allowing players to plan their shots. The flyover can be captured using a gyro-stabilized helicopter and additional image stabilization can be applied to the video clip asset during post-production. Motion graphic assets can be super-imposed on the video clip assets to create a rich presentation of yardage markers, pin placements, hazard markers, out of bounds markers, green slope, ground contour, wind speed, wind direction, club recommendation. The motion graphic assets can provide players with specific, timely, and location-based tips when, for example, the wind is high or from a specific direction at a particular location.

In the example of FIG. 6, two digital golf media can be presented or displayed for the first golf hole: digital golf media 110-1-1 and digital golf media 110-1-2 (collectively referred to as “digital golf media 110-1”). Each of the digital golf media 110-1 comprises one or more assets 112 (not shown in FIG. 1). As shown in FIG. 6, the digital golf media 110-1 includes two assets 112, namely a main video clip asset 602, which can be a flyover video clip asset, and a further video clip asset 604. For digital golf media 110-1-1, the further video clip asset 604-1 is a video clip asset featuring a post-roll advertisement for a time of day such as morning. For digital golf media 110-1-2, the further video clip asset 604-2 is a video clip asset featuring a post-roll advertisement for a different time of day such as twilight. In this example, the redirect engine 126 changes the association of the code 108 from digital golf media 110-1-1 to digital golf media 110-1-2 upon a redirect parameter comprising a time of day parameter. Upon sensing the code 108, different digital golf media is delivered to the user device 102 based on location and time considerations.

FIG. 7 depicts an alternative digital golf media 110-1-1′ comprising the main video clip asset 602-1, main motion graphic asset 702-1, and main audio track asset 704-1. In one example, the main video clip asset 602-1 is a flyover video of the golf hole, the main motion graphic asset 702-1 is a super-imposed rendering of the yardage markers from the teeing grounds for the golf hole, and the main audio track asset 704-1 is an audio narration of the golf hole features. The digital golf media 110-1-1′ can include additional assets selected from the motion graphics assets 714-1, 714-2, 714-e and corresponding audio track assets 716-1, 716-2, 716-e depending on the pin placement for the golf hole. Pin placement also known as hole location (e.g., left, right, central, front and back position) can change based on administrator preferences or settings. For example, motion graphic asset 714-1 and audio track 716-1 can represent the first of four possible pin placements. The first pin placement may be selected according to course administrator preferences. The audio track asset 716 and the motion graphic asset 714 can provide players with insights on yardage, and tips on where to play their shots. As shown in FIG. 7, the digital golf media 110-1-1′ can also include pre-roll video assets 708-1, 708-2, 708-b, and/or pre-roll audio track assets 712-1, 712-2, 712-d, post-roll video assets 604-1, 604-2, 604-a and/or post-roll audio track assets 710-1, 710-2, 710-c. The digital golf media 110-1-1′ can also include a text asset 706-1 comprising a written commentary about the golf hole.

In one example with reference to FIG. 8, the digital golf media 110-1-1′ includes a navigable interface 800 that provides hyperlinks 802 to other golf holes. For example, after the main video asset of the digital golf media 110-1-1′ has been streamed or displayed on the user device 102, the navigable interface 800 can be displayed permitting access to additional digital golf media 110.

The digital golf media of FIG. 6 and FIG. 7 can be assembled in advance using manual video production techniques or, in alternative examples, can be assembled or streamed by the server 116 on demand. In one example, the digital golf media are uploaded as audio-video files to YouTube™ or another user generated media database.

As used in this specification, the phrase digital golf media encompasses topographical information such as flyover videos exposing landscape features that can assist player performance over a round of play. Use of the term flyover refers to a recorded or simulated flight over a specific location, usually at low altitude. Digital golf media can also include targeted advertisements including time-of-day or day-of-week announcements or promotions and can be delivered to the user devices 102. The digital golf media can include motion graphics representing course features such as yardage markers, pin placement markers, fairway markers, hazard markers, and the like. In one example, the digital golf media comprises a flyover video clip asset, audio track asset, a pre-roll or a post-roll advertisement including video and audio, and text content describing hole features. In one example, the assets 112 are optimized for streaming from the media database 128 over the network 114 to the user devices 102.

Advantageously, by employing the methods disclosed herein, dynamic or changing digital golf media can be delivered that is contextual, relevant, and timely providing enhanced and efficient delivery of course information to user devices 102 at relevant times or locations during a round of play.

While a number of exemplary aspects and examples have been discussed above, those of skill in the art will recognize certain modifications, permutations, additions and sub-combinations thereof.

What is claimed is:

1. A method comprising the steps of, in a user device including a processor:
sensing a code at a golf course location using a sensor coupled to the processor;
accessing a link to digital golf media from the code, wherein the link is determined based on one or more redirect parameters; and
displaying the digital golf media on a display coupled to the processor.

2. The method according to claim 1 wherein the code is posted on a sign at a teeing ground location.

3. The method according to claim 1 wherein the sensor is selected from one of a QR code sensor, an NFC tag reader, and a shortlink reader.

4. The method according to claim 1 wherein the sensor comprises a GPS sensor and the sensing step comprises sensing a proximity of the user device to the golf course location.

5. The method according to claim 4 wherein upon detecting a threshold proximity of the user device to the golf course location, the displaying step is performed automatically.

6. The method according to claim 1 wherein the redirect parameters are selected from one or more of: a time of day parameter, a day of week parameter, a week of month parameter, a month of year parameter, a weather parameter, a location parameter, and an administrator-determined parameter.

7. The method according to claim 1 wherein the digital golf media comprises media assets selected from one or more of: a video clip asset, a motion graphics asset, an audio track asset, a pre-roll advertisement asset, a post-roll advertisement asset, and a text asset.

8. The method according to claim 7 wherein the user device is a mobile device and the digital golf media is formatted for mobile devices.

9. The method according to claim 1 wherein the user device comprises a network interface device coupled to the processor and the accessing comprises sending the one or more redirect parameters to a server over a network using the network interface device, and receiving the link to the digital golf media over the network.

10. The method according to claim 9 wherein the receiving comprises streaming the digital golf media from a media database.

11. A device comprising:
a processor;
a sensor coupled to the processor for sensing a code posted on a sign at a golf course location;
means for accessing a link to digital golf media from the code, wherein the link is determined based on one or more redirect parameters; and
a display coupled to the processor for displaying the one or more digital golf media.

12. The device of claim 11 wherein the means for accessing comprises a memory including a client application loaded on the device.

13. A server comprising:
a memory maintaining a database of associations between codes and digital golf media;
a network interface device for communicating over a network with one or more user devices; and
a processor coupled to the memory and the network interface device configured to respond to queries of the memory received at the network interface device, wherein the responding comprises adjusting the associations between codes and digital golf media based on one or more redirect parameters.

14. The server according to claim 13 wherein the one or more user devices comprise a sensor for sensing a code at a golf course location.

15. The server according to claim 14 wherein the code is posted on a sign at a teeing ground location.

16. The server according to claim 14 wherein the sensor is selected from one of:
a QR code sensor, an NFC tag reader, and a shortlink reader.

17. The server according to claim 14 wherein the sensor comprises a GPS sensor and the sensing comprises sensing a proximity of the one or more user devices to the golf course location.

18. The server according to claim 14 wherein the redirect parameters are selected from one or more of: a time of day parameter, a day of week parameter, a week of month parameter, a month of year parameter, a weather parameter, a location parameter, and an administrator-determined parameter.

19. The server according to claim 14 wherein the digital golf media comprises media assets selected from one or more of: a video clip asset, a motion graphics asset, an audio track asset, a pre-roll advertisement asset, a post-roll advertisement asset, and a text asset.

20. The server according to claim 14 further comprising a media database and the responding comprises streaming digital golf media to the one or more user devices from the media database.
